(19) United States
(12) Patent Application Publication
(10) Pub. No.: US 2026/0210406 A1
(43) Pub. Date: Jul. 23, 2026

(54) SENSORIZED BEARING RING AND ASSOCIATED METHODS FOR MANUFACTURING A SENSORIZED BEARING RING

(71) Applicant: AKTIEBOLAGET SKF, GOTEBORG (SE)

(72) Inventors: Marcus C. ANDERSSON, Mölndal (SE); Lukasz Wojciech KOWALCZYK, Dabrówka (PL)

(21) Appl. No.: 19/449,885

(22) Filed: Jan. 15, 2026

(30) Foreign Application Priority Data
Jan. 23, 2025 (DE) 102025102417.0

(51) Int. Cl. F16C 41/00; G01D 5/353

(52) U.S. Cl. CPC F16C 41/00; G01D 5/35316; F16C 2223/46; F16C 2233/00

(57) ABSTRACT

A sensorized bearing ring includes a metallic ring member having a core, the core having a radially outer surface and a radial inner surface, and a layer of metal on the radially inner surface or on the radially outer surface. The layer of metal is a laser metal deposition layer that has a hardness greater than a hardness of the core. At least one groove extends into the core, a sensor member is mounted in the groove and the groove is sealed. Also an associated method.

### CROSS-REFERENCE

This application claims priority to German patent application no. 10 2025 102 417.0 filed on January 23, 2025, the contents of which are fully incorporated herein by reference.

### TECHNOLOGICAL FIELD

The present disclosure is directed to a sensorized bearing ring and to a method for manufacturing a sensorized bearing ring.

### BACKGROUND

Rolling bearings are well-known mechanical components in rotating machinery that function to carry loads while allowing a relative rotation between their bearing rings via rolling elements, such as balls and rollers, that roll on raceways of the rings.

Rolling bearings are often a key critical wear component of a machine. It is therefore sometimes desirable to equip them with sensors to measure their condition to prevent failures and plan maintenance. In addition, sensorized bearings can often provide much information about the condition of the machinery itself, providing valuable data to operators about loads, temperature, rotating speed, to give a few examples.

As the possibilities to transmit data are ever increasing, so are the opportunities to measure more points in machinery, for instance to provide a more refined servicing of the same based on actual needs. Preferably, the sensors should be placed close to a raceway of the ring to get an accurate signal.

Existing solutions to provide bearings with sensors that can be over rolled are either expensive or not reliable. Sensors can be applied onto the raceway in different ways, but the will be worn out quickly by the rolling elements. Bearings can also be equipped with optical fibers underneath the raceway. This is technically good from sensing and reliability perspective, but very expensive and difficult to manufacture, since the tracks for the optic fiber need to be hard milled on the bearing rings after grinding. Thus, this solution is only used for special applications or for testing purposes.

Thus, there is a need to provide reliable sensorized bearings in a cost-efficient manner.

### SUMMARY

An aspect of the disclosure is to solve the problems indicated above, and to provide an improved method for manufacturing a sensorized bearing ring.

The disclosure is directed to a sensorized bearing ring comprising a metallic ring member having a core and at least an inner or outer layer manufactured by laser metal deposition (hereinafter “the layer”), the hardness of the core being lower than the hardness of the layer, wherein at least one groove is formed in the layer and one sensor member is mounted into the groove, the groove being sealed.

Laser Metal Deposition, or LMD, is an additive manufacturing and surface engineering process that uses a laser as a heat source to melt and deposit metallic material onto a substrate. This material, often supplied in the form of powder or wire, is introduced through a nozzle and melts as it passes through the laser beam, creating a strong metallurgical bond with the base material. Layer by layer, the process can be used to build up material, repair damaged components, or add functional coatings to enhance surface properties such as wear resistance or corrosion protection.

The laser metal deposition facilitates remanufacturing despite severe damage to functional surfaces. As the layer manufactured by laser metal deposition may be remanufactured, the cost of the sensor member per life cycle is significantly reduced.

The hardness of a core of the bearing ring is in particular significantly lower than the hardness of the layer of the bearing ring, making the groove easier to machine onto the layer. It may also allow tailoring the thickness of the layer and thereby optimizes the manufacturing cost for laser metal deposition.

The layer may be manufactured by laser metal deposition of stainless steel. In this case, the laser metal deposition brings stainless steel properties to the bearing ring, such as corrosion resistance of debris resistance. Preferably, the thickness of the layer of the bearing ring is lower than the thickness of the core of the bearing ring. Preferably, the core of the bearing ring is ductile. Preferably, the layer is formed on a cylindrical surface of the core of the bearing ring.

Advantageously, the sensor member comprises an optical fiber having at least one fiber Bragg grating. Optionally, the optical fiber is bonded to the bottom of the groove with laser metal deposition. In one embodiment, the groove is sealed with silicone. In another embodiment, the groove is sealed with laser metal deposition.

The disclosure also concerns a sensorized bearing comprising an inner ring, an outer ring and at least one row of rolling elements arranged between raceways provided on the inner and outer rings, wherein at least one of the inner and outer rings is a sensorized bearing ring as described above.

In a first embodiment, the outer ring comprises an outer layer manufactured by laser metal deposition, a groove being formed in the core of the outer ring. In a second embodiment, the inner ring comprises an inner layer manufactured by laser metal deposition, a groove being formed in the core of the inner ring. In a third embodiment, the outer ring comprises an inner layer manufactured by laser metal deposition, a groove being formed in the core of the outer ring. In a fourth embodiment, the inner ring comprises an outer layer manufactured by laser metal deposition, a groove being formed in the core of the inner ring.

The disclosure also concerns a first method for manufacturing a sensorized bearing ring comprising the steps of: providing a metallic ring member comprising a core and at least an inner or outer layer manufactured by laser metal deposition, the hardness of the core being lower than the hardness of the layer of the ring member; forming at least a groove onto the core and the layer of the ring member; mounting at least one sensor member into the groove; and

sealing the groove.

The disclosure also concerns a second method for manufacturing a sensorized bearing ring comprising the steps of: providing a metallic ring member comprising a core; forming at least a groove onto the core of the ring member from an inner or outer surface of the core; mounting at least one sensor member into the groove; and manufacturing an inner or outer layer by laser metal deposition onto the inner or outer surface of the core, the hardness of the core being lower than the hardness of the layer of the ring member.

In one embodiment of the first method, the step of sealing the groove comprises the sealing of the groove with silicone. In another embodiment of the first method, the step of sealing the groove comprises the sealing of the groove with laser metal deposition.

Optionally, the second method further comprises, before or after the step of manufacturing, a step of sealing the groove. Optionally, the step of sealing of the second method comprises the sealing of the groove with a material distinct from the material deposited by laser metal deposition.

Advantageously, according to the first or second method, the step of mounting at least one sensor member into the groove comprises the mounting of an optical fiber into the groove, the optical fiber comprising at least one fiber Bragg grating. The optical fiber with the fiber Bragg grating ensures the collection of operational data in real time and the constantly procession of the operational data. In this way, the performance of the bearing ring will be predictable and maximized.

Optionally, the first or second method further comprises the bonding of the optical fiber to the bottom of the groove with laser metal deposition.

The disclosure also concerns a method for manufacturing a sensorized bearing comprising an inner ring, an outer ring and at least one row of rolling elements arranged between raceways provided on the inner and outer rings, wherein at least one of the inner and outer rings is manufactured by a method as defined above, the method further comprising a step of assembling a row of rolling elements with the inner and outer rings.

In a first embodiment, the method comprises providing the outer ring comprising an outer layer manufactured by laser metal deposition and forming a groove in the outer layer and in the core. In a second embodiment, the method comprises providing the inner ring comprising an inner layer manufactured by laser metal deposition and forming a groove in the inner layer and in the core. In a third embodiment, the method comprises providing the outer ring comprising an inner layer manufactured by laser metal deposition and forming a groove in the inner layer and in the core. In a fourth embodiment, the method comprises providing the inner ring comprising an outer layer manufactured by laser metal deposition and forming a groove in the outer layer and in the core.

In a fifth embodiment, the method comprises providing the inner ring comprising the core, forming the groove onto the core, and manufacturing an outer layer by laser metal deposition onto the inner ring. In a sixth embodiment, the method comprises providing the inner ring comprising the core, forming the groove onto the core, and manufacturing an inner layer by laser metal deposition onto the inner ring. In a seventh embodiment, the method comprises providing the outer ring comprising the core, forming the groove onto the core, and manufacturing an inner layer by laser metal deposition onto the outer ring. In an eighth embodiment, the method comprises providing the outer ring comprising the core, forming the groove onto the core, and manufacturing an outer layer by laser metal deposition onto the outer ring.

### BRIEF DESCRIPTION OF THE DRAWINGS

Other advantages and features of the disclosure will appear from the detailed description of embodiments of the disclosure, which are non-limiting examples, illustrated on the appended drawings of which:

FIG. 1 is a perspective view of a sensorized bearing according to an embodiment of the

presented disclosure.

FIG. 2 is a detail view of the outer ring of the bearing of FIG. 1,

FIG. 3 is a flow chart illustrating a manufacturing method according to a first example of the disclosure.

FIG. 4 is a flow chart illustrating a manufacturing method according to a second example of the disclosure.

### DETAILED DESCRIPTION

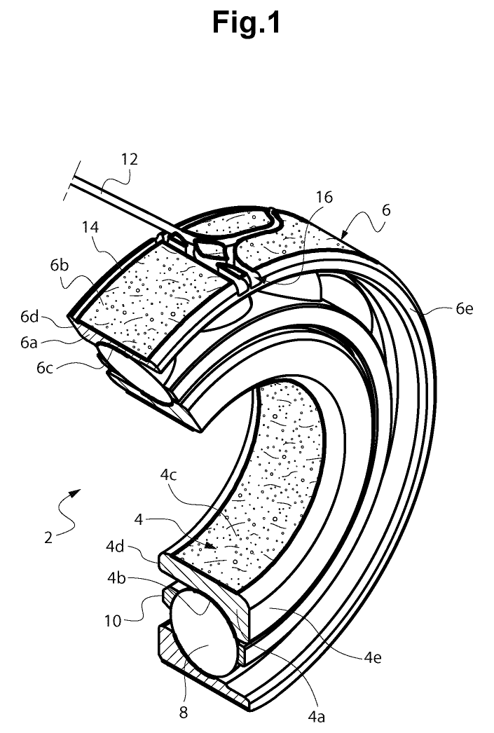

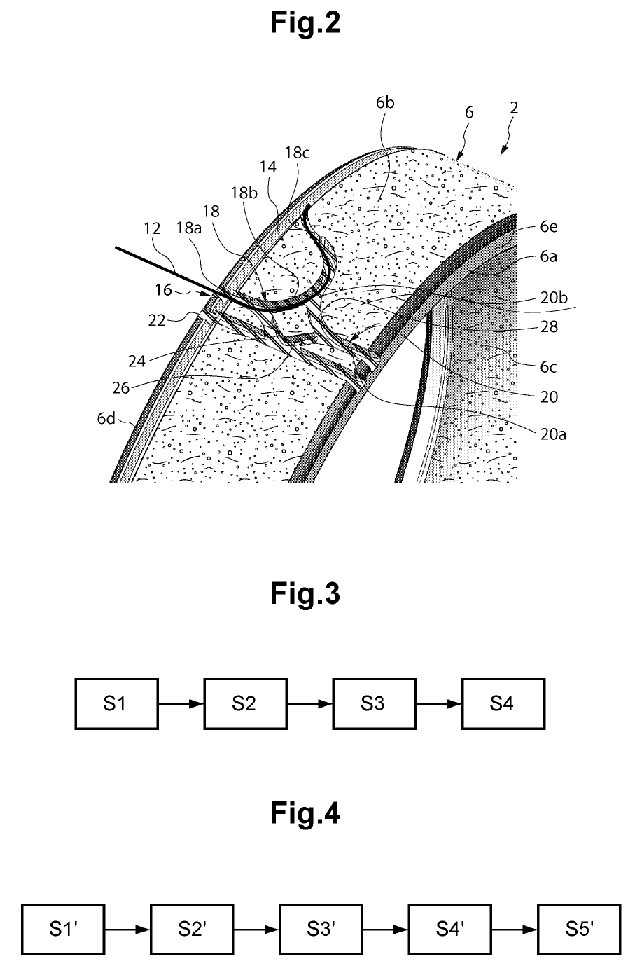

FIGS. 1 and 2 illustrate a sensorized bearing 2 comprising an inner ring 4, an outer ring 6 and a row of rolling elements 8, such as balls, arranged between the inner and outer rings 4, 6, and a cage 10.

The inner ring 4 comprises a core 4a, a radial outer layer 4b and a radial inner layer 4c, the core 4a being located radially between the radial outer and inner layers 4b, 4c of the inner ring 4. The inner surface of the inner layer 4c of the inner ring 4 defines the inner surface of the inner ring 4, and the outer surface of the outer layer 4b of the inner ring 4 defines the outer surface of the inner ring 4. The outer layer 4b is formed on an outer cylindrical surface of the core 4a. The inner layer 4c is formed on an inner cylindrical surface of the core 4a. The outer surface of the inner ring 4, which radius is slightly smaller than the radius of the rolling elements 8, provides an inner raceway for the rolling elements 8.

Both outer and inner layer 4b, 4c of the inner ring 4 are manufactured by a laser metal deposition process. Thus, the hardness of the core 4a is lower than the hardness of both outer and inner layers 4b, 4c. The thickness of the outer layer 4b is less than the thickness of the core 4a. The thickness of the inner layer 4c is also less than the thickness of the core 4a.

The inner ring 4 also comprises first and second frontal surfaces 4d, 4e which axially delimit the inner ring 4.

Alternatively, the inner ring 4 may have no outer and inner layer 4b, 4c manufactured by laser metal deposition. In that case, the inner surface of the core 4a of the inner ring 4 defines the inner surface of the inner ring 4 and the outer surface on the core 4a of the inner ring defines the outer surface of the inner ring 4.

The outer ring 6 comprises a core 6a, a radial outer layer 6b and a radial inner layer 6c, the core 6a being located radially between the radial outer and inner layers 6b, 6c of the outer ring 6. The inner surface of the inner layer 6c of the outer ring 6 defines the inner surface of the outer ring 6, and the outer surface of the outer layer 6b of the outer ring 6 defines the outer surface of the outer ring 6. The outer layer 6b is formed on an outer cylindrical surface of the core 6a. The inner layer 6c is formed on an inner cylindrical surface of the core 6a. The inner surface of the outer ring 6, which radius is slightly greater than the radius of the rolling elements 8, provides an outer raceway for the rolling elements 8.

Both the outer and inner layer 6b, 6c of the outer ring 6 are manufactured by a laser metal deposition process. Thus, the hardness of the core 6a is lower than the hardness of both outer and inner layers 6b, 6c. The thickness of the outer layer 6b is lower than the thickness of the core 6a. The thickness of the inner layer 6c is lower than the thickness of the core 6a.

The outer ring 6 also comprises first and second frontal surfaces 6d, 6e which axially delimit the outer ring 6. The outer ring 6 has an axial length equal to the axial length of the inner ring 4.

The bearing 2 may be of the ball bearing type. However, the disclosure is not limited to ball bearing and may be applied to tapered roller bearings, spherical roller thrust bearings, four-point angular contact ball bearings, deep groove ball bearings, thrust ball bearings, and to any other bearings taking into account combined axial and radial loads.

The bearing 2 is equipped with a sensor member mounted in a groove of the outer ring 6 of the bearing 2. The sensor member is able to monitor the axial and radial loads of the bearing 2. More precisely, the sensor member comprises an optical fiber 12 having a plurality of fiber Bragg gratings, notably evenly spread around the circumference of the outer ring 6 of the bearing 2.

The outer ring 6 comprises a circumferential groove 14, formed in the core 6a and in the outer layer 6b of the outer ring 6, at the vicinity of the first frontal surface 6d and parallel to the first frontal surface 6d. The outer ring 6 also comprises a multi branches groove 16 provided on the core 6a and on the outer layer 6b of the outer ring 6.

The sensor member, particularly the optical fiber 12, is in the multi branches groove 16 and extends towards the circumferential groove 14. The optical fiber 12 comprises a sensing part, including the fiber Bragg gratings, which comes into the circumferential groove 14. An optical signal of the sensing fiber is further analyzed by an optical interrogator (not shown).

The optical fiber 12 may be partly surrounded by a protecting jacket (not referenced). The sensing part of the optical fiber 12 is not surrounded by a protecting jacket and may be called “naked fiber”. The sensing part may be bonded in the circumferential groove 14, for example bonded to the bottom of the circumferential groove 14 with laser metal deposition.

As an alternative, circumferential and multi branches grooves 14, 16 could be provided on the core 4a and on the inner layer 4c of the inner ring 4.

The multi branches groove 16 comprises a first branch 18 that extends axially inward from a first portion of the first frontal surface 6d of the outer ring 6 and then curves approximately 180 degrees to return to a second portion the first frontal surface 6d of the outer at a location circumferentially spaced from the first portion of the first frontal surface 6d.

The multi branches groove 16 further comprises a second branch 20 that extends axially inward from the second frontal surface 6e of the outer ring 6 and connects to the first branch 18.

The first branch 18 comprises a first portion 18a axially extending from the first frontal surface 6d of the outer ring 6, a second portion 18b extending from the first portion 18a and curved along a first radius of curvature, and a third portion 18c extending from the second portion 18b towards the first frontal surface 6d of the outer ring 6 and curved along a second radius of curvature. The third portion 18c comes out in the circumferential groove 14 of the outer ring 6.

The first, second and third portions 18a, 18b, 18c form the first branch 18 of the multi branches groove 16 extending from the first frontal surface 6d into the circumferential groove 14 of the outer ring 6.

The second branch 20 of the multi branches groove 16 comprises a first portion 20a that extends axially from the second surface of the outer ring 6 and a second portion 20b that extends from the first portion 20a of the second branch 20 and curves along a third radius of curvature.

The first portion 20a of the second branch 20 is coaxial with the first portion 18a of the first branch 18. The first and second portions form 20a, 20b the second branch 20 of the multi branches groove 16 extending from the second frontal surface 6e into the first branch 18.

The two branches 18, 20 of the multi branches groove 16 form a particular shape close to Greek letter lambda (λ).

Here, the sensor member, particularly the optical fiber 12, is in the first branch 18 of the multi branches groove 16.

The multi branches groove 16 enables the sensor member, particularly the optical fiber 12, to exit the outer ring 6 in either of the axial directions by selecting the first or second branch 18, 20 of the multi branches groove 16. The shape of the multi branches groove 16 enables the optical fiber 12 to exit the outer ring 6 in both axial directions without bending the optical fiber 12 below a minimum bending radius and allows the sensing part of the optical fiber 12 to be particularly close to the element to be sensed.

The shape of the multi branches groove 16 is for illustrative purposes only. Alternatively, it is possible to design multi branches groove with other shapes.

As illustrated in FIGS. 1 and 2, an additional routing groove 22 distinct from the multi branches groove 16 may be provided, if required, on the core 6a and on the outer layer 6b of the outer ring 6. Alternatively, the additional routing groove 22 may be provided on the core 4a and on the inner layer 4c of the inner ring 4 when the multi branches groove 16 is provided on the inner ring 4 typically for installation in which the outer ring is configured to rotate.

The additional routing groove 22 extends axially from the first frontal surface 6d to the second frontal surface 6e of the outer ring 6 and is parallel to the first portions 18a, 20a respectively of the first and second branches 18, 20 of the multi branches groove 16.

The outer layer 6b of the outer ring 6 further comprises a first oblique groove 24 connecting the first portion 18a of the first branch 18 of the multi branches groove 16 to the additional routing groove 22 and a second oblique groove 26 connecting the first portion 20a of the second branch 20 of the multi branches groove 16 to the additional routing groove 22. The first oblique groove 24 is angled along an axis opposite to the axis of inclination of the second oblique groove 26. Alternatively, the first and second oblique grooves may be provided on the core 4a and on the inner layer 4c of the inner ring 4 when the multi branches groove 16 is provided on the inner ring 4.

The additional routing groove 22 is configured to receive a second sensor member, particularly a second optical fiber associated for sensing loads of a second bearing, for example as described in the document DE 102019214 488 A1 (family member: US 2021/088393).

As shown in FIG. 2, the circumferential groove 14, the multi branches groove 16, the additional routing groove 22, and the first and second oblique grooves 24, 26 are each sealed, here with silicone 28. Alternatively, the circumferential groove 14, the multi branches groove 16, the additional routing groove 22, and the first and second oblique groove 24, 26 are each sealed via laser metal deposition.

FIG. 3 illustrates a method for manufacturing a sensorized bearing ring of the sensorized bearing 2.

The process starts with step S1 of providing a metallic ring member, for example a step of providing the outer ring 6, comprising a core and at least an inner or outer layer manufactured by laser metal deposition, and here comprising the core 6a and the outer layer 6b manufactured by laser metal deposition. Alternatively, the laser metal deposition of the inner or outer layer is carried out, during the manufacturing method, before step S1.

The process continues with step S2 of forming a groove into the core and into the layer of the ring member, and here a step of forming the circumferential groove 14, the multi branches groove 16, the additional routing groove 22, and the first and second oblique groove 24, 26 into the core 6a and into the outer layer 6b.

The process continues with step S3 of mounting of at least one sensor member into the groove, and here a step of mounting the optical fiber 12 in the multi branches groove 16 and in the circumferential groove 14.

Preferably, step S3 comprises the bonding of the optical fiber 12 to the bottom of the groove with laser metal deposition, and here to the bottom of the multi branches groove 16 and to the bottom of the circumferential groove 14.

The process ends with step S4 of sealing the groove, and here a step of sealing the circumferential groove 14, the multi branches groove 16, the additional routing groove 22, and the first and second oblique groove 24, 26 into the outer layer 6b with silicone 28. Alternatively, the groove may be sealed via laser metal deposition.

Optionally, the method further comprises a step of assembling the rolling elements 8 with the inner and outer rings 4, 6 to obtain the sensorized bearing 2.

FIG. 4 illustrates an alternative method for manufacturing a sensorized bearing ring of the sensorized bearing 2. The process starts with step S1’ of providing a metallic ring member, for example a step of providing the outer ring 6, comprising a core, and here comprising the core 6a.

The process continues with step S2’ of forming a groove in the core from an inner or outer surface of the core, and here a step of forming the circumferential groove 14, the multi branches groove 16, the additional routing groove 22, and the first and second oblique grooves 24, 26 onto the core 6a from the outer surface of the core 6a.

The process continues with step S3’ of mounting of at least one sensor member in the groove, and here a step of mounting the optical fiber 12 in the multi branches groove 16 and in the circumferential groove 14.

Preferably, step S3’ comprises the bonding of the optical fiber 12 to the bottom of the groove via laser metal deposition, and here to the bottom of the multi branches groove 16 and to the bottom of the circumferential groove 14.

Optionally, the process continues with step S4’ of sealing the groove, and here a step of sealing the circumferential groove 14, the multi branches groove 16, the additional routing groove 22, and the first and second oblique grooves 24, 26 onto the outer layer 6b with a material distinct from the material deposited by laser metal deposition.

The process ends with step S5’ of manufacturing an inner or outer layer by laser metal deposition onto the inner or outer surface of the core, and here the manufacturing of the outer layer 6b by laser metal deposition.

Alternatively, step S4’ of sealing the groove is carried out, during the manufacturing method, after step S5’. Optionally, the method further comprises a step of assembling the rolling elements 8 with the inner and outer rings 4, 6 to obtain the sensorized bearing 2.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved sensorized bearing ring and associated methods for forming same.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A sensorized bearing ring comprising:
a metallic ring member having a core, the core having a radially outer surface and a radial inner surface,
a layer of metal on the radially inner surface or on the radially outer surface, the layer of metal comprising a laser metal deposition layer,
wherein a hardness of the core is less than a hardness of the laser metal deposition layer, wherein at least one groove extends into the core,
wherein a sensor member is mounted in the groove, and
wherein the groove is sealed.

2. The sensorized bearing ring according to claim 1,
wherein the sensor member comprises an optical fiber having at least one fiber Bragg grating.

3. The sensorized bearing ring according to claim 2,
wherein the optical fiber is bonded to the bottom of the groove via laser metal deposition material.

4. The sensorized bearing ring according to claim 2,
wherein the groove is sealed with silicone or with laser metal deposition material.

5. A sensorized bearing comprising:
a first ring comprising a sensorized bearing ring according to claim 1,
a second ring, and
at least one row of rolling elements arranged between a raceway of the first ring and a raceway of the second ring.

6. A method for manufacturing a sensorized bearing ring comprising:
providing a metallic ring member having a core, the core having a radially outer surface and a radial inner surface and a layer of metal on the radially inner surface or on the radially outer surface, the layer of metal comprising a laser metal deposition layer, and a hardness of the core being less than a hardness of the laser metal deposition layer,
forming a groove through the layer of metal and into the core,
mounting at least one sensor member in the groove; and
sealing the groove.

7. The method according to claim 6,
wherein sealing the groove comprises sealing the groove with silicone or sealing the groove with laser metal deposition material.

8. The method according to claim 6,
wherein sealing the groove comprises sealing the groove with a material distinct from a material of the laser metal deposition layer.

9. The method according to claim 6,
wherein the at least one sensor comprises an optical fiber including at least one fiber Bragg grating.

10. The method according to claim 9, further comprising bonding the optical fiber to a bottom of the groove via laser metal deposition.

11. The method according to claim 6,
wherein the depositing occurs after forming the groove.

12. A method for manufacturing a sensorized bearing ring comprising:
providing a metallic ring member comprising a core;
forming a groove in a first radially facing surface of the ring member;
mounting at least one sensor member in the groove; and
depositing by laser metal deposition a laser metal deposition layer on the first radially facing surface of the ring member,
wherein a hardness of the metal of the laser metal deposition layer is harder than a hardness of the core.

13. The method according to claim 12,
wherein sealing the groove comprises sealing the groove with silicone or sealing the groove with laser metal deposition material.

14. The method according to claim 12,
wherein sealing the groove comprises sealing the groove with a material distinct from the laser metal deposition layer.

15. The method according to claim 12,
wherein the at least one sensor comprises an optical fiber including at least one fiber Bragg grating.

16. The method according to claim 15, further comprising bonding the optical fiber to a bottom of the groove via laser metal deposition.

17. The method according to claim 12,
wherein the depositing occurs after forming the groove.
